(19) United States
(12) Patent Application Publication
(10) Pub. No.: US 2024/0058913 A1
(43) Pub. Date: Feb. 22, 2024

(54) METHOD AND APPARATUS FOR HARMONIZED ENERGY ON THE WORKPIECE MACHINING ZONE

(71) Applicant: OY ECE ECO COOLING ENGINEERING LTD., Helsinki (FI)

(72) Inventors: Kari RINKO, Helsinki (FI); Leo HATJASALO, Helsinki (FI)

(21) Appl. No.: 18/260,062

(22) PCT Filed: Jan. 7, 2022
(86) PCT No.: PCT/FI2022/050016

§ 371 Date: Jun. 30, 2023

Related U.S. Application Data
(60) Provisional application No. 63/134,731, filed on Jan. 7, 2021.

(51) Int. Cl. B23Q 11/10

(52) U.S. Cl. CPC B23Q 11/10

(57) ABSTRACT

The invention relates to machining a workpiece. In the inventive a pair of a workpiece and a tool materials are selected, and the workpiece material machined with the tool. At the same time with the machining there is the step of providing an external, charged gaseous medium to a working zone, workpiece and tool contacts. The formed charged polarity of the gaseous medium depends on the pair of the selected workpiece and the tool materials to harmonize their generated internal thermal energy and electric charge, enthalpy levels and electrochemical reactions in the working zone, workpiece and tool during the machining.

### FIELD OF TECHNOLOGY

The invention relates to machining a workpiece. Especially the invention relates to harmonizing energy on the workpiece machining zone.

### PRIOR ART

The modern objective of metal cutting processes as increased productivity of multiple machining operations. Only feasible option is to increase productivity by increasing the cutting speed. However, it is known that this increase of the cutting speed generates increased cutting temperature and tool wear among the other critical features.

There are today some new challenges in metal cutting; a) the increased use of special alloys with advanced properties and significant tightening of quality requirements for machined parts, b) the increasing global competition, c) the environmental requirements for ecological improvements. Thus, new solutions are needed for global metal cutting industry.

### Short Description

The object of the invention is to provide an alternative way to machine a workpiece. The object is achieved by means of independent claim. The dependent claims illustrate different embodiments of the invention.

An inventive method for machining workpiece material comprises steps of selecting a pair of a workpiece and a tool materials, and machining the workpiece material with the tool. At the same time with the machining there is the step of providing an external, charged gaseous medium to a working zone, workpiece and tool contacts. The formed charged polarity of the gaseous medium depends on the pair of the selected workpiece and the tool materials to harmonize their generated internal thermal energy and electric charge, enthalpy levels and electrochemical reactions in the working zone, workpiece and tool during the machining.

### LIST OF FIGURES

In the following, the invention is described in more detail by reference to the enclosed drawings, where

FIG. 1 illustrates sources of thermal energy generation,

FIG. 2 illustrates shows the principle of emf method,

FIGS. 3 and 4 illustrate a basic configuration of working zone with gaseous medium penetrating in all zones,

FIGS. 5a, 5b, 5c illustrates different neutralization mechanisms,

FIG. 6 illustrates an example of a neutralization current,

FIG. 7 illustrate examples of average densities of ions vs input pressure,

FIG. 8 illustrates temperatures at different setup pressures,

FIG. 9 illustrates an example of a test result of a cutting test set up with carbon steel with different cutting speeds, and

FIGS. 10-14 illustrate different cutting test results,

### DESCRIPTION OF THE INVENTION

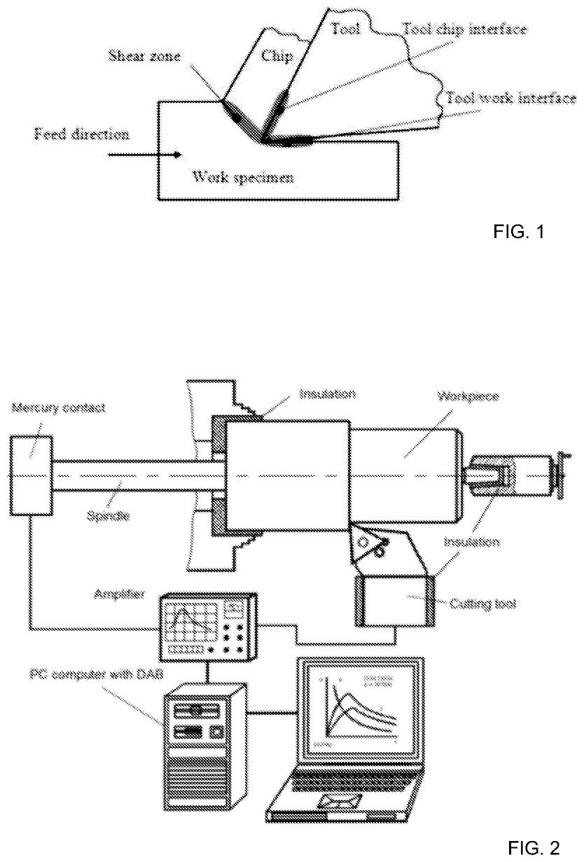

The most known correlations between cutting speed, heat generation and tool life have been investigated many decades with many different theories and models. The generated heat, thermal energy distributions is one of the major topic, which creating the temperature fields in the workpiece, chip and tool. There are three sources of thermal energy generation: I. shear and deformation zone where the layer being cut gradually converts into the chip, II. tool—chip interface where the chip slides over the tool rake face, and III. tool-workpiece interface where the machined surface slide over a small area of the tool flank face. These sources are schematically shown in FIG. 1.

The strongest thermal energy generation is caused in shear/deformation zone accounting on 65-90% and 10-35% of thermal energy is generated due to friction over tool-chip and tool-workpiece interfaces. In machining of different steel around 75-90% of total thermal energy is generated due to plastic deformation. However, the maximum temperature is typically achieved at the tool—chip interface, the temperature in front of the cutting edge of fracture lower by heat advection.

The achieved temperature (thermal energy, balance of exothermic vs. endothermic) can be characterize eg. by electromotive forces (emf). There are different methods and theories, such as the Seebeck emf caused by the junction of dissimilar metals, the Peltier emf. caused by a current flow in the circuit, and the Thomson emf. which results from a temperature gradient in the connected materials. The Seebeck emf. is dependent on the junction temperature, which is known for any junction formed by most common metals, and therefore, the junction of dissimilar metals can be used to measure temperature if the generated emf. is carefully measured. Table 1 shows thermal emf. for some commonly used materials.

TABLE 1

| Metal or alloy | Emf (mV) |
|---|---|
| Cromel (90% Mi, 10% Cr) | +2.4 |
| Iron | +1.8 |
| Molybdenum | +1.2 |
| Tungsten | +0.8 |
| Copper | +0.76 |
| Aluminum | −0.40 |
| Nickel | −1.50 |
| Alumel (1% Si, 2% Al, 0.17% Fe, 2% Mn, 94.83% Ni) | −1.70 |
| Constantan (58% Cu, 40% Ni, 2% Mn) | −3.4 |
| Copel (56.5% Cu, 43.5% Ni) | −3.6 |

Note
Reference junction at 0° C., terminal junction at 100° C.

In the table is presented the thermal e.m.f. in absolute millivolts for some commonly used metals and alloys in conjunction with platinum.

FIG. 2 shows the principle of emf method. Because the tool and work materials are normally different, their contact at the tool—chip and tool—workpiece interfaces forms the hot junction of the tool-work thermocouple. The components of this thermocouple are insulated from the machine and fixtures to eliminate noise in the output signal. This output signal is the e.m.f. voltage which is amplified and then is fed to the data acquisition board plugged into a computer for further analysis.

The machining is based on many technologies. However, there are always material related atoms, molecules and ions involved, wherein electromechanical, triboelectrical, electrochemical process are actively participation between the workpiece and tool. In the machining process, especially in metal cutting, workpiece is typically losing electrons. At the atomic level, cutting workpiece leads to an electric process to occur, wherein valence electrons leave atoms of the workpiece material as cutting tool pushing forward, forming a charged zone in the workpiece, which weakens its strength and eventually causes them to be removed as cutting chip. This type of process is realized in the deformation zone, where the most of the thermal energy is generated. Atoms are losing electrons near the tool and forming positive electrical potential (cations), which requires specific ionization energy level, which is needed to charge the material. This charging process is critical in material cutting and the resulting repulsive force among the ions in workpiece leads to their removal from the workpiece material. In different material has characterized its specific ionization energy level. Thus, the one are of deformation zone can be called ionization zone.

This ionization process is critical in metal cutting in order to continue this repetitive charging. Required ionization energy level is depending on utilized pair of materials, a workpiece and a tool, which are principally defining required ionization energy, the force for remove or add atom electrons. In case of metal cut, atoms are typically losing electrons. Depending on the electrochemical process, it could be exothermic or endothermic, wherein thermal energy is released or absorbed.

The necessary condition for electrochemical reactions is the collision of atoms, molecules and ions of reacting components with material surfaces. When cutting metals, atoms, molecules and ions are in a gas-like state and metal surfaces are in an elastoplastic phase, electrochemically active reactions between them is possible. The smaller the difference in the level of direct and reverse electrochemical reactions is, the less energy activation (ionization energy) is needed. Thus, it is important to optimize the balance of electrochemical reaction (also exothermic and endothermic balance) in order to minimized the required activation energy, which has a direct impact for cutting force, thermal distribution, elastic and plastic deformation.

On the contact surfaces between workpiece and tool appear electric potentials with a fast variation. Thus, the above-mentioned thermocouple phenomenon can be separate in two components: one constant and the other one variable. The constant component depends on the thermoelectric tension and the variable component characterizes the thermoelectronic processes from the surface that is in contact having friction. The thermoelectric current is greater that the thermoelectronic current, and because of this reason, usually the thermoelectric currents used at measuring the average temperature of the cutting tool edge (ref. Seebeck), and the thermoelectronic currents are less researched. Some prior art solutions utilized external electric source by feeding voltage
level on the tool insert and causing polarity effect on the cutting zone. This solution has some influence for machining. However, this approach is not suitable to utilize in the real industrial machinery due to challenges to apply electricity for industrial machinery causing a lot of disturbing electrical interferences. Another approach has been also presented utilizing ionized air in metal cutting, wherein basic trials has been presented. However, there were not disclosed the critical facts between polarities and selected workpiece and tool materials, which is the key topic for thermoelectronic current, control of internal charge, neutralizing and ionic bonding. Thus there was a lack of understanding to provide solid functional method to control and optimize the electromechanical and electrochemical related reactions in the machining.

Based on above description of activation energy and internal charges (thermoelectronic, thermoelectric, etc.) in machining and cutting and challenges to increase the machining speed with normal metal working fluid, etc., this invention can provide a new level of machining achievements. This electromechanical and electrochemical invention is based on the method to harmonize the material machining and cutting activation energy and internal charges on the contact surface and triboelectric energy on the material surface, in order to minimize the generated internal thermal energy, enthalpy level, cutting force and tool wear with increased cutting speed and improved surface roughness. This harmonizing method is based on generated and optimized external, charged gaseous medium (flux) to the working zone, workpiece and tool contacts, wherein formed charged polarity of the gaseous medium depends on the pair of the selected workpiece and the tool materials to harmonizing their generated internal thermal energy and electric charge, enthalpy levels and electrochemical reactions during the machining. The charged gaseous medium is a flow of ionized flux, wherein anion or cation based ions are generated in order to combine and harmonize the electrical charge and electrochemical reactions of working zone materials simultaneously. Selected pair of material need to have optimized gaseous medium (flux) in order to harmonize cationic and anodic polarities and enthalpy levels on the working zone. The gaseous medium may based on ionized air flux with more anion or cations or combinations, having positive or negative polarity or bipolarity depends on the pair of the selected workpiece and the tool materials. Also, other gaseous medium, just as argon, nitrogen or others can be utilized depends on the pair of the selected workpiece and the tool materials in order to achieve preferred ion charge for working zone harmonization. By using said ionized medium the required ionization energy is minimized.

This invention is suitable for conductive, metallic, isolated and coated even non-conductive, non-metallic materials too, wherein high static charge is involved and can be harmonized by ion neutralization and/or recombination. The charged gaseous medium can penetrate in all working zones and all surfaces, having an impact on surface energy, electron and atom repulsion forces, surface oxidation and ionic bond or lattice formation, etc., including the tool, which can consist of tool holders, tools, inserts and other machining tools.

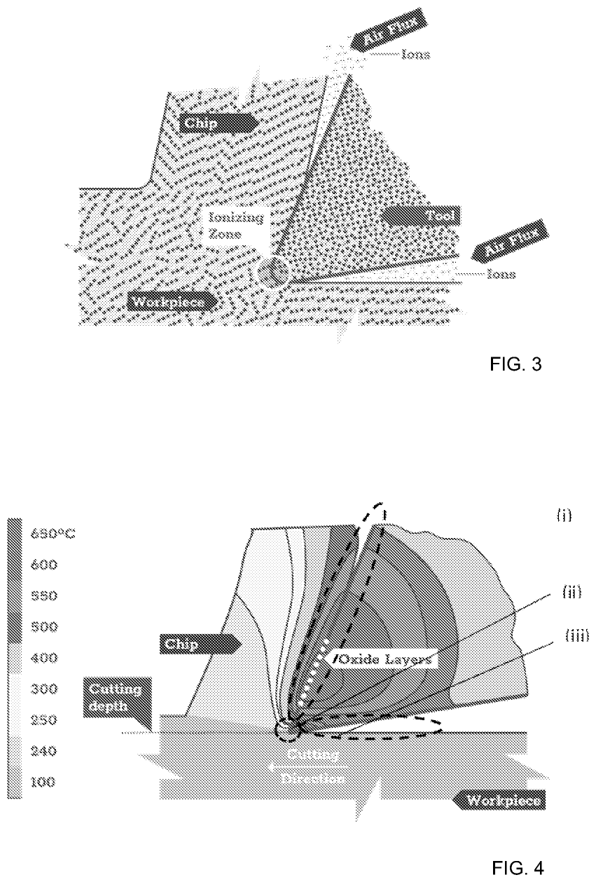

Following FIGS. 3 and 4 are presenting the basic configuration of working zone with gaseous medium, which penetrates in all zones and surfaces to harmonize the machining and cutting energy by charge exchanging and ionic bonding. Another figure shows the basic temperature distribution (released heat by energy transformation in the cutting zone) on the tool and workpiece material, wherein a primary (i), secondary (ii) and tertiary (iii) harmonizer zones are presented. Additionally, harmonizing can effect further for tool and workpiece surfaces, depending on the pair of materials. The main harmonizer zones are on the workpiece and tool interface; thus primary harmonizer zone does not has negative influence for internal shear and deformation zone in terms of elastic-plastic deformation and its necessary heat generation (ref. plastic deformation). Moreover, it has positive influence for interaction of tool wear, such as plastic deformation, texture change, oxidation, electrochemical reactions due to characterized ion neutralization, recombination or bonding, which depends on the pair of the selected workpiece and the tool materials. The charged gaseous medium surrounding a workpiece and tool in the cutting zone causes the electrons in the metal to redistribute in such a way that the charge of medium is always be attracted toward the metal surfaces and interacting between solid surfaces and medium. Besides the standard attractive interaction, which is due to evanescent waves, there is also repulsive interaction due to propagating Cerenkov waves. This fundamental electrodynamics need to take into account whenever dealing with charge distributions.

When an ionized atom is projected onto a solid surface, an excited solid-atom system is formed. The Ion-Neutralization process is a process by which the excited solid-atom system de-excite itself.

The metal surface is represented by the Fermi level (εF, the electrochemical potential of electrons in the metal) and the vacuum level (εvac, the energy of an electron at rest, in vacuum, φ=work function).

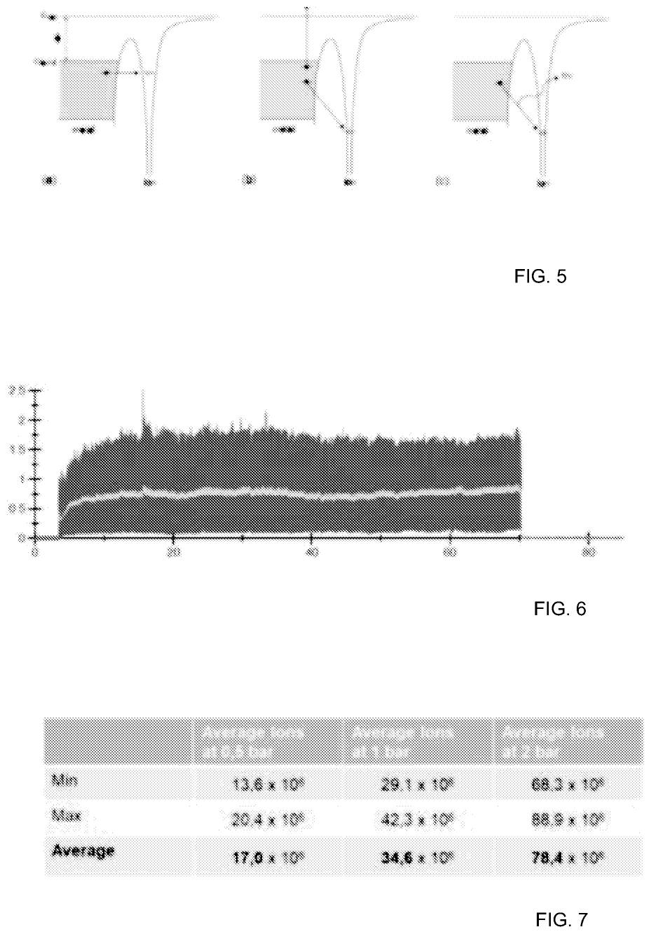

Different neutralization (de-excitation) mechanisms can take place:
I) Resonance Neutralization: An electron in the metal band tunnels out from the surface to an excited state of the ion that is energetically degenerate with the surface state (FIG. 5a).
II) Auger Neutralization: One electron in the metal band tunnels out from the surface to a more tightly bound state of the Ion. Energy is conserved by the emission of a second (Auger) electron (FIG. 5b) or a photon (FIG. 5c).

The Auger electron is in the metal surface and can be excited above the vacuum level if the energy balance is positive.

These processes are important, because of the role they play in secondary-electron-emission phenomena, in gas-discharge phenomena and in the surface-ionization mechanism. The electronic transitions involved in the processes mentioned above are almost independent of the kinetic energy of the incident particle but are governed by its potential energy of excitation.

Over the experiment development about the relation between the electric current at cutting zone and cutting edge wear was observed that the cutting “thermos current”, as more high it gets, the more it influences the intensity of wear in case if the workpiece is at anode (positive pole) and the cutting tool is at cathode (negative pole). The direction of the electrical current depends on the pair of selected workpiece and tool materials. In one case, external current was applied directly on the tool with certain voltage level, the wrong polarity caused increased tool wear than normal cutting set up. Thus, it is very important to understand selected materials and polarities in order to optimized charged gaseous medium with the correct polarity.

The motion of ions in an electric field constitutes an electric current whose density depends on the number of ions in the air and the rate at which they move away from or toward the source of the electric field. The relationship between the current density and the electric field is known as the conductivity of the air. This conductivity may vary with the polarity. If an object is charged, an electric field is established around it. The field strength will vary from point to point but is always proportional to the charge. If the object is surrounded by air ions of both polarities, a current carried by the ions of polarity opposite to its charge will flow toward the object. This neutralization current is proportional both to the charge on the object and to the relevant conductivity of the surrounding air. This neutralization current was measured with very sensitive Keithley measurement unit, when steel workpiece was cut with a basic tungsten carbide tool (insert). In FIG. 6 the measured average current level is 0.75 mA and resonance range is 0.1 mA—1.6 mA with ionized gaseous medium. Sampling recording time is 65 seconds. Parameters and polarity of ionized gaseous medium can be measured and optimized by using emf test setup described above.

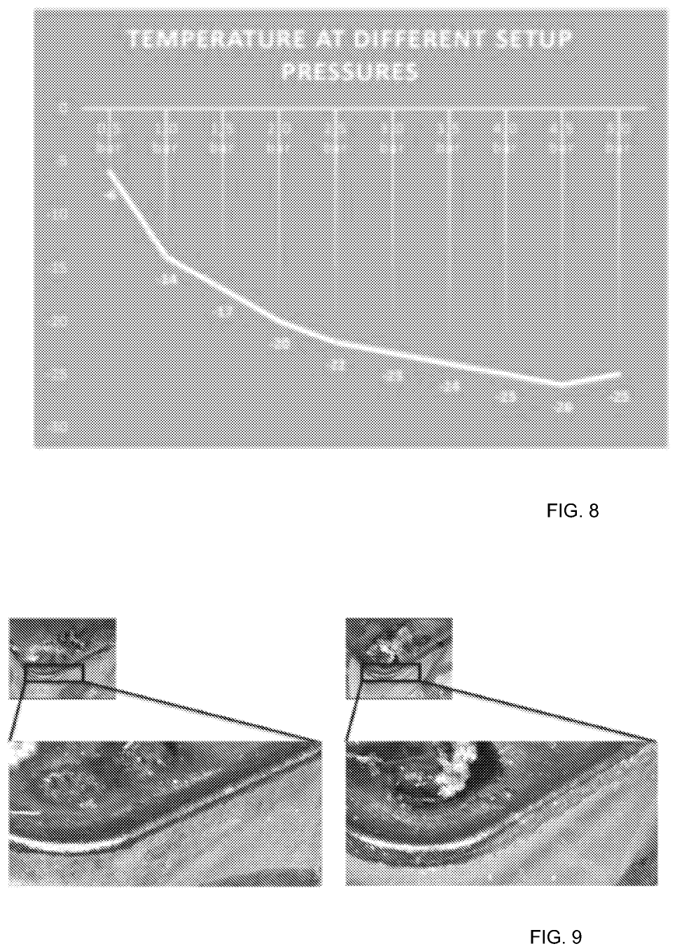

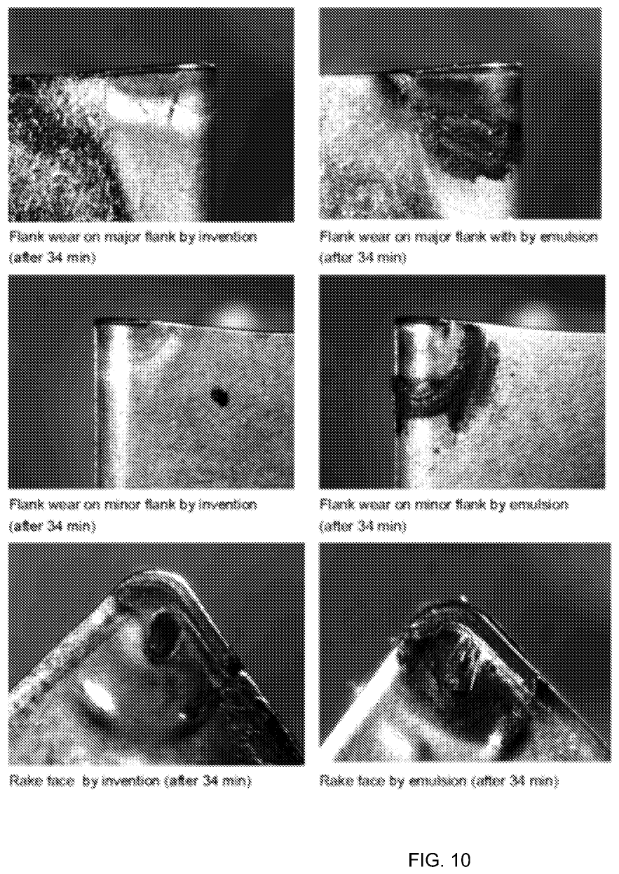

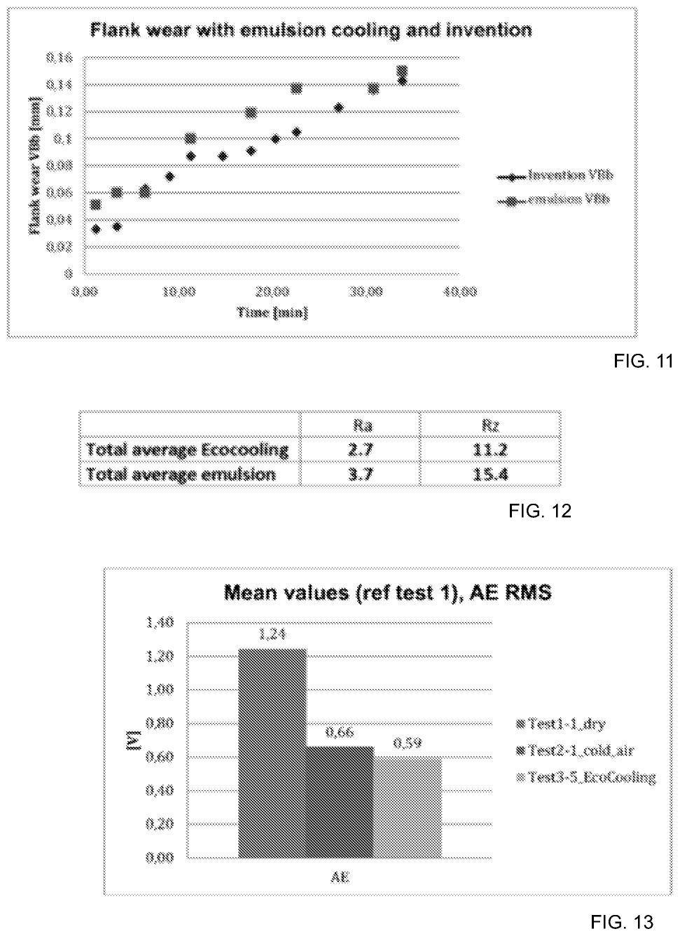

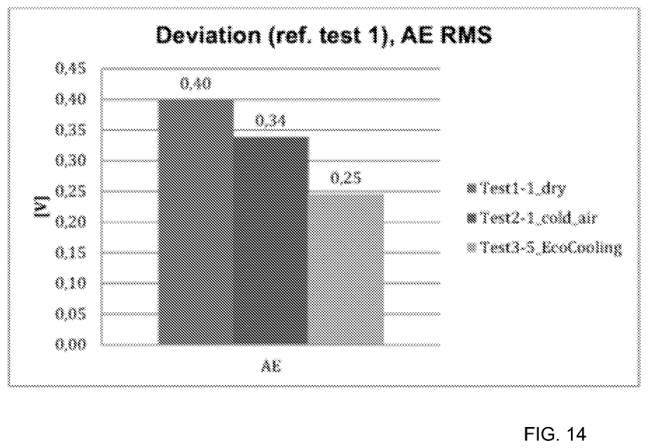

Main parameters for ionized gaseous medium are polarity, temperature, pressure of ionized flux, average density of ions vs input pressure. In the FIGS. 7 and 8 are presented some basic values for the temperature vs pressure and the ion density vs pressure. High density of ions is required in order to have any influence for the cutting zone. The medium temperature can be positive or negative, typically cold temperature, because it will support current level on the cutting zone.

The field in the surrounding air from the charge gas causes the neutralizing current I—, which is also the total charge's decay or neutralization rate;

$$\\ {I}^{-} = \frac{{q}_{a}}{{ε}_{o} ρ {}^{-}} = \frac{\frac{{C}_{a}}{{C}_{a} + {C}_{d}} \cdot q}{{ε}_{o} ρ {}^{-}} = - \frac{d}{dt} .$$

$$\\ wherein ;$$

$$\\ q = {q}_{o} \cdot {e}^{- \frac{t}{{τ}^{+}}} ,$$

and the time constant τ⁺ is;

$$\\ {τ}^{+} = \frac{{C}_{a} + {C}_{d}}{{C}_{a}} \cdot {ε}_{o} ρ {}^{-}$$

For a given ion environment, equations give the rate of neutralization by air ions of a negative charge as a function of the geometrical and dielectric location of the charge. Similar symmetric equations hold true for the neutralization of positive charges.

Present invention was tested with several machining methods and materials. Typical methods to validate test results were utilized. Some of basic methods were tool wear analysis by mechanical, chemical and visual, such as flank and rake wear. The machined surface roughness was one typical method as well. Another new method was acoustic emission (AE) measurement, which is capable to show material plastic deformation, tool wear, chip formation, etc. This is interesting method to measure an impact of harmonized cutting energy with inline method. This new method with the accurate force control system can be utilized for gaseous medium optimization for different pair of materials. Thermal energy can be measured by emf-method too, but it can be derived from force control results as well.

Following figures are demonstrating different cutting test result with Imatra 520 round steel bar. Flank wear is compared between emulsion and invention methods, wherein invention method demonstrating lower tool wear. Machines surface roughness was improved by invention as well. With acoustic emission (AE) RMS signal was measured to compare friction values between different cutting methods. The invention method achieved lower friction signal and very stable results comparing other dry cutting methods

Following table 2 presents some cutting test set up with carbon steel with different cutting speeds. Coolant vs Eco Cooling (gaseous medium) has been compared. Ra values on the workpiece surface after cutting are in the better level.

Carbon Steel

TABLE 2

| Cutting method | | Machine Type | | Raw Materials | | Spec | | Tool Holder | | | Sandvik tool tips | | | |
|---|---|---|---|---|---|---|---|---|---|---|---|---|---|---|
| Axial | | Okuma | | Normal carbon | | | | DWLNR 2525 | | | WNMG 08 04 | | | |
| Turning | | LU25 | | steel (rod, bar) | | S355J2H | | 08 T-MAX P | | | 08-PM 4425 | | | |
| | | | Coolant run | | | | | | Eco Cooling run | | | | | |
| | | | | | | | | | | | | | Tool/ | |
| Cutting | Cutting | Cutting | | Cutting | | | Tool/ | AE/ | | Cutting | | | Insert | |
| Speed Vc | Feed | Depth | | time | Tool | | Insert | Radial | | time | Tool | | temper- | |
| (m/min) | (mmin) | ap(mm) | Test ID | (min) | wear | Ra | temp | forces | Test ID | (min) | wear | Ra | ature | AE |
| 355 | 0.34 | 2.5 | CS1 | 15 | | 3.0-3.5 | 30 | 9-10% | ESC1 | 15 | | 2.7-3.2 | | 10-13% |
| 355 | 0.34 | 2.5 | CS2 | 15 | | 3.5-4.0 | 35 | 9-10% | ESC2 | 15 | | 2.3-2.7 | | 9-11% |
| 400 | 0.34 | 2.5 | CS3 | 15 | | 3.5-4.2 | 40 | 10% | ESC3 | 15 | | 2.2-2.6 | | 9-11% |
| 430 | 0.34 | 2.5 | CS4 | 15 | | 4.4-5.5 | | 10-11% | ESC4 | 15 | | 1.4-1.8 | | 9-11% |

The FIG. 9 showing some tool wear results in this cutting test. On the left side has a tool insert with Eco Cooling (gaseous medium) and the right side has a tool insert with conventional coolant. Obvious differences could be realized, conventional coolant use cause much higher tool wear than charged gaseous medium. There are many evidences of similar improvements, gaseous medium can achieve the same or better cutting quality and improving the tool life.

So, the invention relates to a method for machining workpiece material, the method comprising the steps of selecting a pair of a workpiece and a tool material; machining the workpiece material with the tool; and at the same time with the machining, providing a flow of pressurized, cooled ionized gaseous medium to a working zone wherein ionization level and polarity of the gaseous medium is depend on the pair of the selected workpiece and the tool materials to harmonizing their generated internal thermal energy and electric charge, enthalpy levels and electrochemical reactions in the working zone, workpiece and tool during the machining.

In the method and the apparatus, the ionization level and polarity of the gaseous medium can be controlled.

Further, in the method and the apparatus the tool selection in the selection of the pair can comprise a selection of the tool shape and tool material.

Measurements like emf, internal charge (current, potential, electric field), AE and other existing measurements can be used in the method and the apparatus in order to optimize the performance according to the invention.

This invention has capability to implement and utilize it in several different machining methods, milling, drilling, cutting, etc. including CNC and other machining centers. There is no limit to apply this basic invention for multiple machining processes.

It is evident from the above that the invention is not limited to the embodiments described in this text but can be implemented utilizing many other different embodiments within the scope of the independent claims.

1. A method for machining workpiece material, the method comprising:
selecting a pair of a workpiece and a tool materials,
machining the workpiece material with the tool;
characterized in that with the machining utilization of thermoelectric and thermoelectric current data by emf method between the workpiece and the tool to define the direction of the electric current and polarities, which depending on the pair of selected workpiece and tool material:
generating charged gaseous medium, polarity of the gaseous medium depends on the pair of the selected workpiece and the tool materials
providing an external, charged gaseous medium to a working zone, workpiece and tool surface and interfaces;
the gaseous medium providing ion neutralization and/or recombination in the working zone, workpiece and tool during the machining
measuring parameters and polarity of the charged gaseous medium,
controlling the ionization level and polarity of the charged gaseous medium.

2. The method of claim 1, wherein the charged gaseous medium is a flow of ionized flux.

3. The method of claim 1, wherein the ionized flux is air, nitrogen, argon or other gaseous medium depends on the pair of the selected workpiece and the tool materials.

4. The method of claim 1, wherein the charged gaseous medium has a temperature is below or above 0° C. depends on the pair of the selected workpiece and the tool materials.

5. The method of claim 1, wherein the ionized flux is generated by corona AC/DC or alpha ionization, collisional or photoionization or electrostatic spraying.

6. The method of claim 1, wherein the gaseous medium has positive or negative polarity or bipolarity depends on the pair of the selected workpiece and the tool materials.

7. The method of claim 1, wherein the charged gaseous medium is harmonizing the internal thermal energy and electric charge, enthalpy levels by ion neutralization, recombination and ionic bonding on the working zone, workpiece and tool materials

8. The method of claim 1, wherein the harmonizing by charged gaseous medium is formed in different zones; a primary, secondary and tertiary harmonizer zones and workpiece and tooling surfaces.

9. The method of claim 1, wherein selecting a pair of a workpiece and a tool materials are from the group of electrical conductive or non-conductive or combination.

10. The method of claim 1, wherein selecting a pair of a workpiece and a tool materials are partially or fully isolated or coated.

11. The method of claim 1, wherein the tool selection in the selection of the pair materials comprises a selection of the tool shape and tool material.

12. The method of claim 1, wherein a tool consists of tool holders, tools, inserts and other machining tools.

13. The method of claim 1, wherein ionized flux is optimized with group of parameters and function of their interaction such as polarity, temperature, pressure of ionized flux, average density of ions vs input pressure, temperature vs input pressure.

14. (canceled)

15. The method of claim 1, wherein the tool selection in the selection of the pair comprises a selection of the tool shape and tool material.

16. The method of claim 1, wherein emf, internal charge (current, potential, electric field), AE and/or other existing measurements are used in the method optimization.

17. The method of any of claim 1, wherein the charged gaseous medium minimizing cutting force and tool wear with increased cutting speed and improved surface roughness.

18. The method of claim 1 wherein said charged gaseous medium supports resulting atom repulsive forces, thereby reducing ionization energy of the workpiece material.
